(19) United States
(12) Patent Application Publication
(10) Pub. No.: US 2018/0283668 A1
(43) Pub. Date: Oct. 4, 2018

(54) MODULAR POWER SYSTEM FOR CABINETS

(71) Applicant: Sensio America, LLC, Carol Stream, IL (US)

(72) Inventors: Jeffery A. Conrady, Aurora, IL (US); Gary B. Rutherford, Wheaton, IL (US); Paul Bardwell, Rexford, NY (US)

(21) Appl. No.: 15/943,385

(22) Filed: Apr. 2, 2018

Related U.S. Application Data
(60) Provisional application No. 62/480,178, filed on Mar. 31, 2017.

(51) Int. Cl. F21V 23/02; H02G 3/18; A47B 87/00; A47B 77/08

(52) U.S. Cl. CPC F21V 23/02; H02G 3/18; F21Y 2115/10; A47B 77/08; A47B 87/007

(57) ABSTRACT

A modular power system for cabinets includes a power module configured to be installed on a cabinet, a driver configured to be connected to a power source and to be coupled to the power module, and a component or accessory configured to be coupled to the power module and to be powered by the driver. A method includes factory installing one or more power modules of the modular power system on a cabinet system and factory installing one or more components or accessories on the cabinets and connecting the one or more components or accessories to the one or more power modules. A cabinet system includes the modular power system defining multiple different and separately power zones.

### RELATED APPLICATION DATA

This patent is related to and claims priority benefit of U.S. Provisional Application Ser. No. 62/480,178 filed on Mar. 31, 2017 and entitled “Modular Power System for Cabinets.” The entire content of this prior filed provisional application is hereby incorporated herein by reference.

### BACKGROUND

### 1. Field of the Disclosure

This disclosure is generally related to power delivery for storage cabinets, and more particularly to a modular power system for cabinetry.

### 2. Description of Related Art

It is becoming common to incorporate lighting features or lighting systems into storage cabinets and cabinet systems when such cabinet systems are installed. For example, new kitchen designs often incorporate at least one cabinet lighting solution or feature. Such cabinet systems can include overhead cabinets with under-cabinet lighting to illuminate the countertop surfaces beneath the overhead cabinets. Such cabinet systems can also include interior cabinet lighting, particularly in overhead cabinets with glass panels in the cabinet doors, to illuminate the cabinet interiors and to highlight visible objects stored within such cabinets. Such cabinet systems can also include upper soffit lighting for illuminating areas above the tops of the overhead cabinets.

LED lights, and particularly LED lighting strips, are commonly used for lighting features and solutions for cabinet systems. The components of these lighting features are typically installed on site, once the cabinets are delivered, and during and/or after the cabinets are installed at the site. Sometimes only one of the three types of the cabinet lighting noted above is installed with a particular cabinet system or installation. Sometimes any two of the three types of the cabinet lighting are installed on a particular cabinet system or installation. Sometimes, all three types of the cabinet lighting are installed on a particular cabinet system or installation.

No matter the cabinet system or installation, the method of installing such lighting features or solutions is tedious, time consuming, and often complicated. The wiring that is required to accommodate cabinet lighting features must be run between and among the cabinets and is also connected on site. Power must be connected both to the dedicated site power source and to the wiring that has been installed on site on the cabinets. The LED lighting strips and/or other types of lights and/or powered accessories are also selected, trimmed to fit, and installed on the cabinets on site.

In some cases, power is connected to the lighting features by plugging in or hard wiring a power adapter to the on-site power source, such as a 120V AC system and then connecting the power adapter to the lighting features. In some cases, the lighting features are intended to be a switched system. A switched wall socket may be provided at the site and the power adapter may be plugged into the switched socket. In other cases, one or more wall switches to operate the lights may be installed on site. The wall switches are then hard wired to the electrical power source at the site and hard wired either to the power adapter for the lights or directly to the wiring for the lights. Sometimes, the different types of lighting features noted above are provided and are each connected to a separate electrical power source, switch, or the like for independent control of each type of lighting. This can further complicate the on-site installation of the lighting systems.

During a conventional installation of an illuminated cabinet system, the installer must prepare the lights for each cabinet, which may include cutting each LED strip to the appropriate length. The installer must also attach or install each light strip or element in the desired location for each cabinet, whether on top, within, or under each cabinet. The installer must also drill holes in the cabinets where wiring will run between adjacent cabinets to connect lights of one particular feature on each cabinet to one another. The installer must also cut, trim, and run or route all of the wiring for each light strip or feature and then must connect all the wiring to the power source and to the appropriate light strips or features. If the installer has two or three types or zones of lighting features, such as the under cabinet, interior cabinet, or above cabinet lighting, to install on multiple cabinets, the installer must measure for and drill holes for each feature, install the lights for each feature, prepare, run, and connect all of the wiring for each feature, and the connect power to each feature.

### SUMMARY

In one example, according to the teachings of the present disclosure, a cabinet system with a modular power system includes at least one cabinet and a power module on the at least one cabinet. The power module is configured to be coupled to a power source for delivering power to the cabinet and to be coupled to a component or accessory that requires power from the power source at an installation site for the at least one cabinet.

In one example, the power module can be factory installed on the at least one cabinet.

In one example, the power module can include a power input module installed on the at least one cabinet.

In one example, the power module can include a power output module installed on the at least one cabinet.

In one example, the power module can include a power input module and one or more separate power output modules installed on the at least one cabinet at the factory.

In one example, the power module can include a power module with both power input capability and power output capability. The power module can be installed on the at least one cabinet at the factory.

In one example, the cabinet system can include a driver for delivering power to the power module. The driver can be connected to the power module at the factory or at the installation site.

In one example, the cabinet system can include at least two cabinets. Each cabinet can include a power module. Each of the power modules can be factory installed. In one example, a driver can be coupled to one of the power modules for delivering power to both of the power modules.

In one example, the power module can be a power output module including multiple sets of output jacks. Each set of output jacks can be configured for a different and separately powered zone of the modular power system.

In one example, the cabinet system can include a power input module having multiple power input jacks, one for each of a different and separately powered zone of the modular power system. The power input module can be connectable to the power output module and each power input jack can be configured to optionally connect to a driver to deliver power to a corresponding set of output jacks.

In one example according to the teachings of the present disclosure, a modular power system for cabinets includes a power module configured to be installed on a cabinet. The power module defines multiple different and separately powered zones. A driver is configured to be connected to a power source and to be coupled to the power module. A component or accessory is configured to be coupled to the power module and to be powered by the driver.

In one example, the power module can include a power input module, which can be configured to be installed on a cabinet at the factory.

In one example, the power module can include a power output module, which can be configured to be installed on a cabinet at the factory.

In one example, the power module can include a power input module and a separate power output module, and each can be configured to be installed on a cabinet at the factory and connected to one another.

In one example, the power module can include both power input capability and power output capability and can be configured to be installed on a cabinet at the factory.

In one example, the driver can be configured to be installed on a cabinet at the factory and can be configured to be connected to a power source at an installation site for the cabinet.

In one example, the driver can be configured to be connected to the power module at the factory.

In one example, the power module can include multiple sets of output jacks. Each set of output jacks can be configured for a different and separately powered zone of the modular power system.

The cabinet system of claim 18, wherein the power module further comprises multiple power input jacks, one for each of the different and separately powered zones, wherein each power input jack is configured to optionally connect to a driver to deliver power to the corresponding set of output jacks.

In one example according to the teachings of the present disclosure, a method of installing a modular power system for cabinets includes the steps of selecting a power module of a modular power system, installing the power module on a cabinet at a factory, and delivering the cabinet to an installation site.

In one example, the method can include the steps of coupling a driver to the power module and connecting the driver to a power source at the installation site.

In one example, the method can include the steps of installing a component or accessory on the cabinet at the factory and coupling the component or accessory to the power module at the factory or at the installation site.

In one example, the above-mentioned cabinet system, method, and method can include one or more components or accessories in the form of LED strips. The LED strips can be secured to the cabinets at the factory.

### BRIEF DESCRIPTION OF THE DRAWINGS

Objects, features, and advantages of the present invention will become apparent upon reading the following description in conjunction with the drawing figures, in which:

FIG. 1 shows a view of a generic cabinet arrangement and installation.

FIG. 2A shows a simplified depiction of one example of various components for a modular power system for a cabinet arrangement and installation in accordance with the teachings of the present disclosure.

FIG. 2B shows one example of a LED light strip, which is an example of a powered lighting element or accessory configured to be powered by the modular power system of FIG. 2A.

FIGS. 3A-3E show various views of a power input module or bridge of the modular power system components of FIG. 2.

FIG. 3F shows a simplified schematic of the power input module or bridge of FIG. 3A.

FIGS. 4A-4E show various views of a power output module or bridge of the modular power system components of FIG. 2.

FIG. 4F shows a simplified schematic of the power output module or bridge of FIG. 4A.

FIG. 5 shows one example of a modular power system using the components of FIG. 2 and in accordance with the teachings of the present disclosure.

FIG. 6 shows the cabinet arrangement and installation of FIG. 1 including the components the modular power system of FIGS. 2 and 5.

FIG. 7 shows another example of various components for a modular power system for a cabinet arrangement and installation in accordance with the teachings of the present disclosure.

### DETAILED DESCRIPTION OF THE DISCLOSURE

The disclosed modular power system may include one or more modular elements or bridges, hereinafter “modules” or “power modules” that are attached to or mounted onto or near cabinetry. The disclosed modular power system may also include a cabinet system or installation that has a modular power system that utilizes such modules or bridges. The disclosed modular power system and cabinet system may also include a method of installing such a modular power system utilizing such modules. The disclosed modular power system and cabinet system solve or improve upon one or more of the above-known and/or other problems and disadvantages with prior known cabinet lighting and power systems.

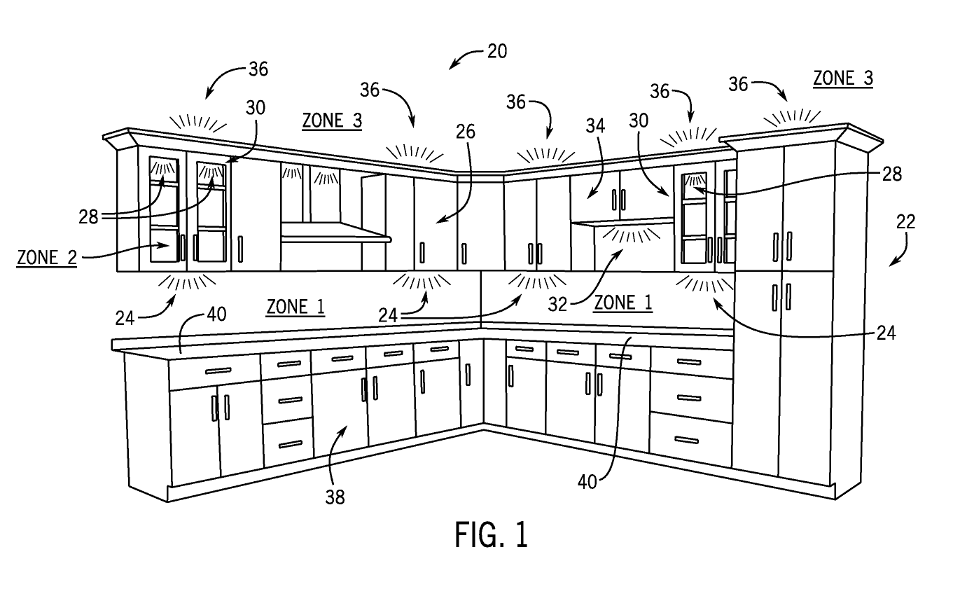

Turning now to the drawings, FIG. 1 shows one example of a cabinet system or installation 20. FIG. 1 depicts an image of kitchen cabinets or cabinetry 22 with lighting employed. The cabinet system 20 depicted in FIG. 1 includes examples of countertop lighting 24 emanating from under a plurality of overhead cabinets 26. The cabinet system 20 also includes interior lighting 28 emanating from within the interior of glass door cabinets 30. The depiction further includes accessory lighting 32 emanating from beneath shorter height cabinets 34 and/or between spaced apart taller cabinets of the overhead cabinets 26. The depiction also includes soffit lighting 36 emanating from above the overhead cabinets 26.

The cabinet system 20 depicted in FIG. 1 is only one of innumerable different possible examples of a kitchen cabinet installation or system that is suitable for the disclosed modular power system. Other cabinet systems and installations, such as for bathrooms, work rooms, bedrooms, closets, and the like, as well as those specific to kitchens, may also benefit from employing the disclosed modular power system. The cabinet system and installation image of FIG. 1 is provided only to illustrate how the disclosed modular power system may be employed to improve upon or enhance the cabinetry and the installation process for such cabinetry. The cabinet system 20 in this example also shows base cabinets 38 below countertops 40 and the and overhead cabinets 26. Virtually any cabinet arrangement and installation method could be enhanced using the disclosed modular power system. Regarding the overhead cabinets 26, some may be joined together side to side at the same height. Others may be joined together side to side at different heights (known as castling), though not shown herein. Some cabinets may have different depths and some cabinets may have shorter heights, such as the shorter cabinets 34 in this example, than adjacent cabinets.

As depicted in FIG. 1, the cabinet system 20 may have a plurality of different lighting zones, power zones, or both. In the illustrated example, the cabinet system 20 includes three (3) different zones of lighting or power requirements. For ease of description, a first zone, Zone 1 may include countertop or under-cabinet lighting or under-cabinet power access. A second zone, Zone 2, may include interior cabinet lighting or interior cabinet power access. A third zone, Zone 3, may include above-cabinet or soffit lighting or above-cabinet or soffit power access. The Zones 1-3 define three separately powered zones in this example for delivering power for lighting, such as LED lighting, or for delivering power to other powered accessories. As noted below in more detail, a cabinet system may include two (2) zones or four (4) or more zones.

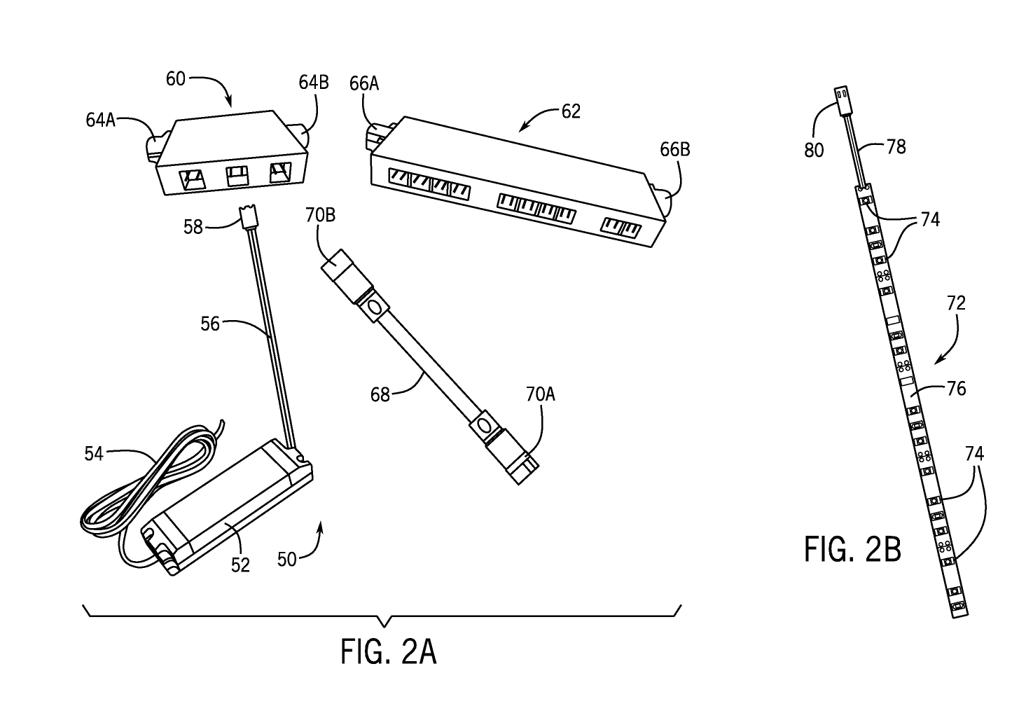

FIG. 2A depicts one example of a modular power system 50 in accordance with the teachings of the present disclosure. The modular power system 50 includes several parts, which are shown generically and in the singular in this figure. The modular power system 50 may include multiple of each or any of the parts, as needed, depending on the configuration and arrangement of a cabinet system and/or the number of zones to be accommodated or created within a cabinet system. The modular power system 50 may include one or more power supplies or power adapters, i.e., hereinafter “drivers 52” that may be provided to deliver appropriate power to a particular zone or to a particular portion of the cabinet system. In one example, the drivers 52 may be configured to adapt 120C standard alternating current (AC) electricity to a 24V direct current (DC) power or another voltage suitable for most electronic devices. Each driver 52, if more than one, of the modular power system 50 may be the same as other drivers of the system or may be different than one or more of the other drivers, depending on the power requirements for a zone or portion of the cabinet system.

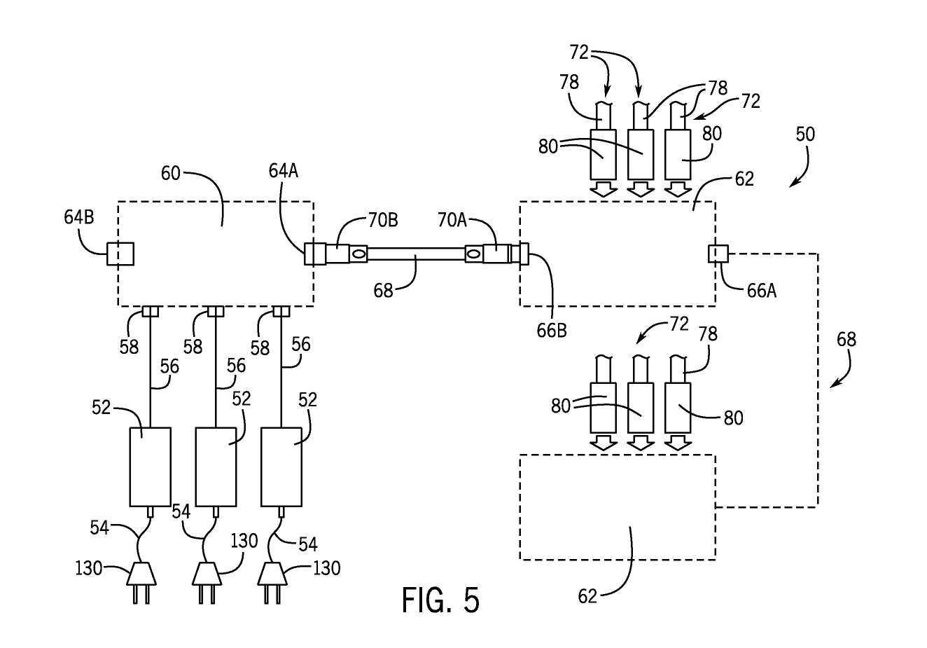

Each driver 52 may be configured having an AC cord 54 or a wire set extending from the driver. The cord 54 is provided to connect the driver 52 to a standard on-site power source (not shown). The cord 54 may have a 2-prong or three-prong plug (not shown but see FIG. 5 below) that is configured to connect to a standard electrical outlet or socket that is connected to the AC power source at the installation site. A switch (not shown) may be coupled to each driver 52 or any desired one or more of the drivers, if desired, to turn the power on and off to the driver and thus to the corresponding zone. The switch may be on the driver 52, in-line on the cord 54, on the outlet or socket at the site, on a wall near the outlet or socket, or the like. Alternatively, any one or more of the drivers 52 may always be powered on. If so, the lights or other powered accessories in the corresponding zone or zones may also always be powered on. Alternatively, the switch or other means may be provided downstream of the driver(s) 52 so as to be able to turn the lights or other powered accessories on or off.

Each driver 52 may also include a lead 56 extending from the driver. The lead 56 is intended to connect to another part of the modular power system 50, as described below. The lead 56 may terminate at a connector or plug 58, such as a relatively common RJ type or ML type plug. The plug 58 is configured to connect to a port or jack, such as a RJ type jack or a ML type jack of the modular power system 50, also as described further below.

The modular power system 50 in this example may also include a plurality of bridges or modules generically depicted in FIG. 2A. Each of these modules is configured to be installed on a cabinet of the cabinet system 20 at the factory. In one example, the modular power system 50 may include a power input bridge or module 60 and one or more power output bridges or modules 62. Each of these modules 60, 62 may also include one piece or part or multiple pieces or parts that together make up or define the module whereby each of the pieces or parts may be installed on a cabinet of a cabinet system 20 at the factory as a part of that module. The power input module 60 is configured having one, two, or more connectors (male or female or other suitable form), which are used to connect the power input module to other modules of the modular power system 50, as described further below. In this example, the power input module 60 includes two of the connectors 64A and 64B. Likewise, each of the power output modules 62 is configured having one, two, or more connectors (male, female, or other suitable form), which are used to connect the power output modules 62 to other modules of the modular power system 50. In this example, each power output module 62 also has two of the connectors 66A, 66B.

The modular power system 50 in this example may also include a plurality of cables 68, cord segments, wiring segments, or the like of different type and/or of different length. Though called cables herein for ease of description only, these cables 68 may include whips, leads, links, cords, lines, power lines, transmission lines, and/or the like. The cables 68 are only generically represented in FIG. 2. However, the cables 68 may be provided in a series or family of cable options having a range of lengths, if desired and if needed. Each cable 68 can be provided with a mating connector 70A, 70B at each end. The mating connectors 70A, 70B (female or male, or other suitable mating form) can be configured to engage the connectors 64A, 64B and 66A, 66B of the power input and output modules 60, 62 to create the modular power system 50 and connect the power modules to one another.

If needed or desired, the connectors 64A, 64B, 66A, 66B and mating connectors 70A, 70B may be provided in a range of different types and sizes or can be standardized to one form. The range of product sizes and/or connector types can be provided to accommodate various connections and standard and non-standard sized cabinets for any installation of the disclosed modular power system 50. The cables 68 may be selectable by the cabinet maker, a user, or an installer. The cables 68 may be pre-fabricated in a series, range, or family of products and may include a mating connector 70A, 70B at each end. Alternatively, the cables 68 may be provided as a relatively long wire with a mating connector 70A or 70B pre-attached at only one end. The wire may be cut to a desired length, and then a second mating connector 70B or 70A may be added to the cut end at the cabinet factory or at an installation site. Alternatively, the cables 68 may be fabricated entirely at the factory during fabrication of a cabinet system 20 or at an installation site using loose connectors and a coil of wire cut to length as needed.

The modular power system 50 may also include, or may be configured to provide power to, lighting elements, powered accessories, powered devices, and the like. These powered lighting elements, accessories, and devices at times may be generically referred to herein as “components.” The components are configured to be connected to and receive power from the modular power system 50. In one example, these components may be or may include lighting elements. In one example, the lighting elements may be LED lighting strips, i.e., LED strips 72, as depicted in FIG. 2B. The LED strips 72 each typically include a plurality of LED's 74 carried on a base strip of material 76. One end of each LED strip 72 may be configured with a lead 78 that has a connector or plug 80, such as a RJ type plug or ML type plug on the free end of the lead. The plug 80 of the LED strip 72 may be connected to a port or jack of a portion of the modular power system 50, also as described further below. Other lighting elements and/or non-lighting components, other than LED strips, may be provided either as a part of the modular power system 50 or as a component that is to be connect to and powered by the system. Each of these other types of components can similarly have a connector or plug that is configured to connect to a portion of the modular power system 50, also as described below.

The LED strips 72 may need to be selected having an appropriate length lead 78 that can reach a power output module 62 on a cabinet. The lead 78 on a component, such as the LED strip 72, may be relatively short, an intermediate length, or relatively long. The desired length may depend on the configuration of the modular power system 50, the size and shape of a cabinet or cabinet system 20, the location of the LED strip 72, and/or the position of the power output module 62 on a cabinet. Similar to the above-mentioned cables 68, a series or family of LED strips 72 or other components may be provided with multiple different length leads 78 and/or different types of plugs 80 to accommodate a variety of cabinet systems 20 and modular power systems 50. Also similar to the above-mentioned cables 68, the LED strips 72 or other components may also be provided in bulk and cut to length and assembled at the factory or on-site as needed. For example, LED strips are often provided in lengthy rolls, cut to length, applied with a lead and plug, and then installed.

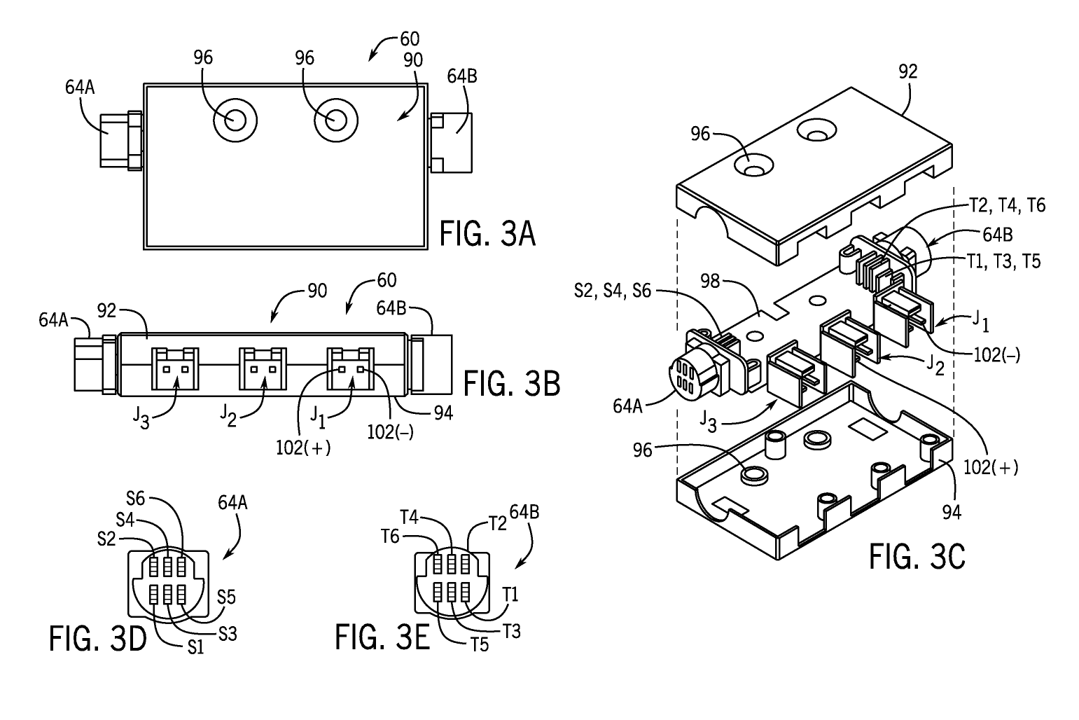

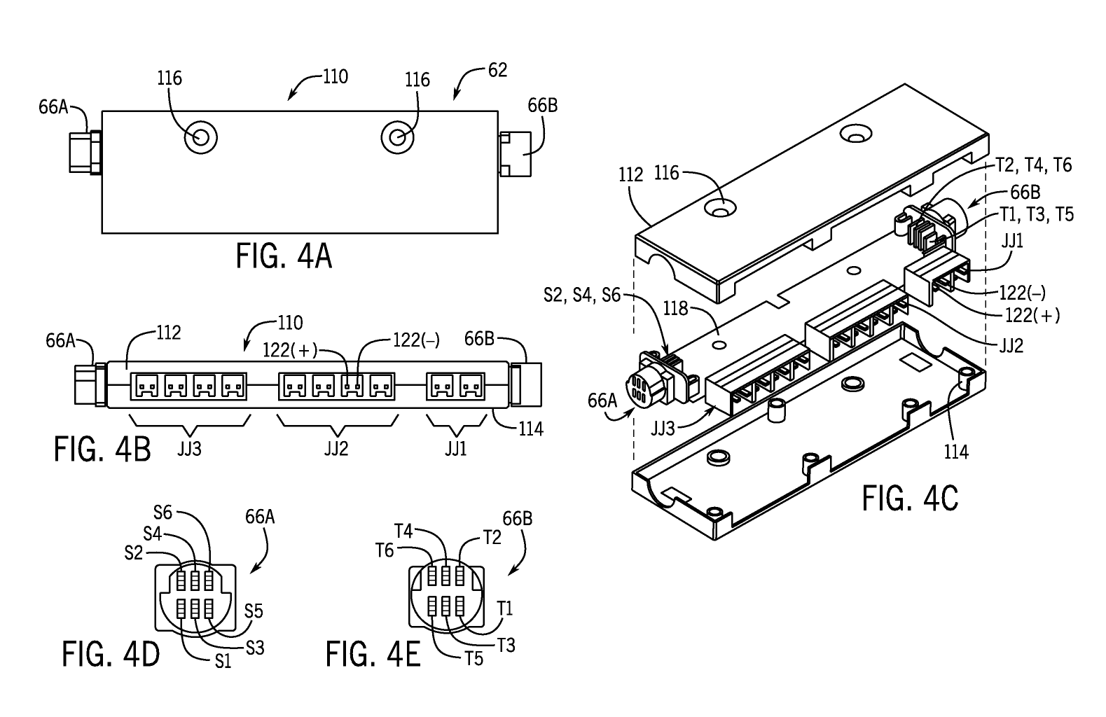

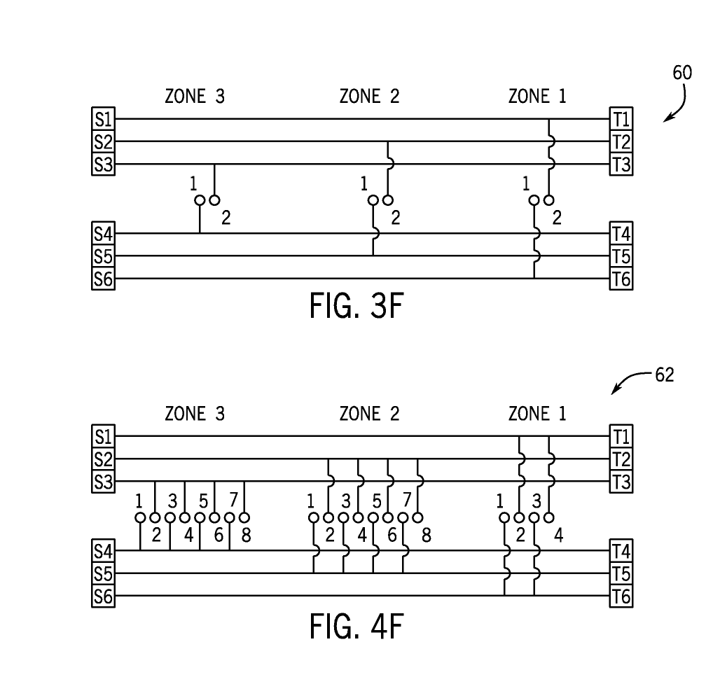

FIGS. 3A-3F depict details of one example of the power input bridge or module 60 of the modular power system 50. In this example, the power input module 60 has a housing 90 with an upper or first part 92 and a lower or second part 94 that are assembled to form a shell around an interior of the housing, as shown in FIGS. 3A-3C. The housing parts 92, 94 can be a plastic material, a metal material, or the like and can be snapped together, welded together, sonically welded together, fastened together, or the like. The housing parts 92, 94 can also have through holes that are aligned with one another when assembled to provide mounting holes 96 through the housing. The mounting holes 96 can be used to mount and secure the power input module 60 to a cabinet. As shown in FIG. 3C, the power input module 60 may include a printed circuit board (PCB) 98 captured in the interior of the housing 90. The PCB 98 may also include a microprocessor (not shown), if desired. The PCB 98 may be a simple design created to distribute power to the connectors 64A and 64B, as described below. Alternatively, the optional microprocessor may be programmed to control power distribution, as well as other functions, for the modular power system 50, if desired, when installed.

In this example, the connectors 64A and 64B are mounted to opposed ends of the PCB 98 of the power input module 60, as shown in FIGS. 3A-3C. The connector 64A is a six-pole female connector and thus has six sockets or receptacles S1-S6. The connector 64B is a six-pole male connector and similarly has six corresponding prongs or terminals T1-T6. In this example, when the power input module 60 is assembled, the female connector 64A and the male connector 64B are disposed at opposite ends of the housing 90, as shown in FIGS. 3A and 3B. As shown in FIGS. 3D and 3E, the six poles, i.e., the sockets S1-S6 of the female connector 64A correspond with the six terminals T1-T6 of the male connector 64B correspond with one another to control power delivery from the power input module 60, as described further below.

The power input module 60 in this example is configured to connect to three of the drivers 52 and thus has three input ports or jacks J1, J2, J3. As shown in FIG. 3C, the three jacks J1, J, J3 are connected to an edge of the PCB 98 between the opposed ends of the housing 90 and are exposed on a side of the housing as shown in FIG. 3B. In this example, the jacks J1, J2, J3 may be RJ type jacks, ML type jacks, or the like. Each jack J1. J2. J3 can have a positive terminal 102(+) and a negative terminal 102(−) as shown in FIGS. 3B and 3C. The jacks J1, J2, J3 are each configured to accept a plug 58 of a driver 52, such as a RJ type plug, a ML type plug, or the like. Power from the driver(s) 52 is thus delivered to the power input module 60 via one or more of the jacks J1, J2, J3 and is distributed via the connectors 64A, 64B. FIG. 3F shows a simplified schematic of the connections between the input jacks J1, J2, J3 and the sockets S1-S6 and terminals T1-T6 of the connectors 64A, 64B. Pairs of the terminals T1-T6 and pairs of the sockets S1-S6 at each of the connectors 64A and 64B are thus electrically connected to deliver power from a specific one of the input jacks J1, J2, J3 to the two connectors 64A and 64B. Specifically, power from a driver 52 plugged into the jack J1 is transmitted via the PCB 98 to the terminals T1 and T6 of the male connector 64B and to the sockets S1 and S6 o the female connector 64A. Also, power from a driver 52 plugged into the jack J2 is transmitted via the PCB 98 to the terminals T2 and T5 of the male connector 64B and to the sockets S2 and S5 of the female connector 64A. Similarly, power from a driver 52 plugged into the jack J3 is transmitted via the PCB 98 to the terminals T3 and T4 of the male connector 64B and to the sockets S3 and S4 of the female connector 64A.

FIGS. 4A-4F depict details of one example of the power output bridge or module 62 of the modular power system 50. In this example, the power output module 62 has a housing 110 with an upper or first part 112 and a lower or second part 114 that are assembled to form a shell around an interior of the housing, as shown in FIGS. 4A-4C. The housing parts 112, 114 can be a plastic material, a metal material, or the like and can be snapped together, welded together, sonically welded together, fastened together, or the like. The housing parts 112, 114 can also have through holes that are aligned with one another when assembled to provide mounting holes 116 through the housing. The mounting holes 116 can be used to mount and secure the power output module 62 to a cabinet. As shown in FIG. 4C, the power output module 62 may include a printed circuit board (PCB) 118 captured in the interior of the housing. The PCB 118 may also include a microprocessor (not shown), if desired. The PCB 118 may be a simple design created to distribute power to the connectors 66A and 66B, as described below. Alternatively, the optional microprocessor may be programmed to control power distribution, as well as other functions, for the modular power system 50, if desired, when installed.

In this example, the connectors 66A and 66B are mounted to opposed ends of the PCB 118 of the power output module 62, as shown in FIGS. 4A-4C. The connector 66A is a six-pole female connector and thus has six sockets or receptacles S1-S6. The connector 66B is a six-pole male connector and similarly has six corresponding prongs or terminals T1-T6. In this example, when the power output module 62 is assembled, the female connector 66A and the male connector 66B are disposed at opposite ends of the housing 110, as shown in FIGS. 4A and 4B. As shown in FIGS. 4D and 4E, the six poles, i.e., the sockets S1-S6 of the female connector 66A correspond with the six terminals T1-T6 of the male connector 66B correspond with one another to control power delivery from the power input module 60, as described further below. In this example, the connectors 66A and 66B are essentially identical to the connectors 64A and 64B on the power input module 60. Likewise, the connectors 70A and 70B of the cables 68 are also female and male connectors and are essentially identical in construction to the connectors 64A and 64B, respectively, and 66A and 66B, respectively, for compatibility.

The power output module 62 in this example is configured to define three power output groups or zones, each powered by a driver 52 connected to a corresponding one of the three input jacks J1, J2, J3 of the power input module 60. As shown in FIG. 4C, the power output module 62 thus has three groupings of output jacks JJ1, JJ2, JJ3. In this example, a first grouping of jacks for a Zone 1 has two jacks JJ1, a second grouping of output jacks for a Zone 2 has four jacks JJ2, and a third grouping of output jacks has four jacks JJ3. Each of the jacks JJ1, JJ2, JJ3 is grouped together by zone or grouping, as shown in FIGS. 4B and 4C. Each of the output jacks JJ1, JJ2, JJ3 is connected to an edge of the PCB 118 between the opposed ends of the housing 110 and are exposed on a side of the housing as shown in FIG. 4B. In this example, the jacks JJ1, JJ2, JJ3 may be RJ type jacks, ML type jacks, or the like. Each jack JJ1, JJ2, JJ 3 can have a positive terminal 122(+) and a negative terminal 122(−) as shown in FIGS. 4B and 4C. The jacks JJ1, JJ2, JJ3 are each configured to accept a plug 80 of a LED strip 72, or of another powered accessory, device, or component, such as a RJ type plug, a ML type plug, or the like. Power from the driver(s) 52 is thus delivered from the power input module 60 via one or more of the jacks J1, J2, J3, and distributed via the connectors 64A, 64B and one of the cables 68 to the power output module 62 to the corresponding jacks JJ1, JJ2, JJ3.

FIG. 4F shows a simplified schematic of the connections between the output jacks JJ1, JJ2, JJ3 and the sockets S1-S6 and terminals T1-T6 of the connectors 66A, 66B. Pairs of the terminals T1-T6 and pairs of the sockets S1-S6 at each of the connectors 66A and 66B are thus electrically connected to deliver power from the two connectors 66A and 66B to a specific one of the output jacks JJ1, JJ2, JJ3. Specifically, power from a driver 52 plugged into the jack J1 of the power input module 60 is transmitted via the PCB 118 of the power output module 62, the terminals T1 and T6 of the male connector 66B, and the sockets S1 and S6 of the female connector 66A to the output jacks JJ1. Also, power from a driver 52 plugged into the jack J2 of the power input module 60 is transmitted via the PCB 118, the terminals T2 and T5 of the male connector 66B, and the sockets S2 and S5 of the female connector 64A to the jacks JJ2. Similarly, power from a driver 52 plugged into the jack J3 of the power input module 60 is transmitted via the PCB 118, the terminals T3 and T4 of the male connector 66B, and the sockets S3 and S4 of the female connector 64A to the jacks JJ3.

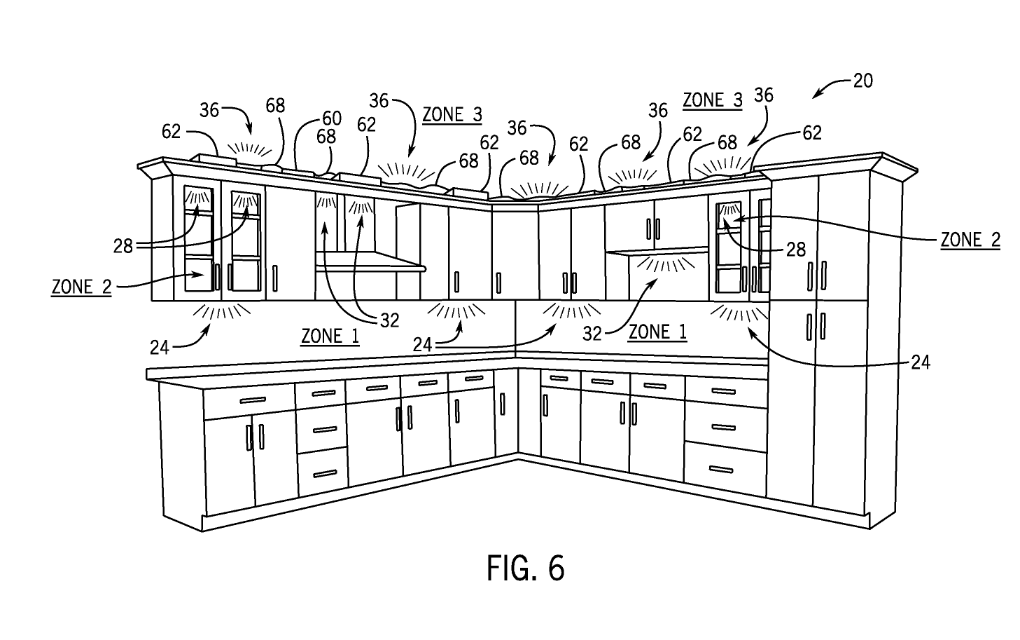

FIGS. 5 and 6 show examples of a modular power system 50 according to the teachings of the present disclosure. In this example, a power input module 60 can be mounted to a cabinet of the cabinet system 20 (FIG. 6). Three drivers 52 (FIG. 5) can be connected to the power input module 60 as described above, one connected to each of the input jacks J1, J2, J3. A female mating connector 70A of a cable 68 can be connected to the male connector 64B of the power input module 60. The male mating connector 70B of the cable 68 can be connected to the female connector 66A of a first power output module 62. The power output module 62 can be mounted to a cabinet of the cabinet system 20 (FIG. 6). The plugs 80 of a plurality of LED strips 72 (FIG. 5) or other powered components or accessories can be connected to various output jacks JJ1, JJ2, and/or JJ3 of the power output module 62. One or more additional power output modules 62 can also be connected in series to the first power output module 62 via additional cables 68. Though not shown in FIG. 5, another cable 68 and one or more additional power output modules 62 can be connected in series to the female connector 64A of the power input module 60 to provide power to additional LED strips 72 or other powered components. Additional LED strips 72 and/or other powered components or accessories can be connected to the additional power outlet module(s) 62. In this example, each driver 52 has a conventional electrical plug 130 that can be plugged into a wall socket of an on-site electrical system.

The LED strips 72 can be mounted to cabinets of the cabinet system 20 in the different zones, such as Zone 1, Zone 2, and/or Zone 3 as represented by the illumination or lighting 24, 28. 32, and 36 depicted in FIGS. 1 and 6. Zone 1 can be illuminated using LED strips 72 that are mounted under the overhead cabinets 26 and the shorter height cabinets 34 to provide the countertop illumination 24 and accessory shelving or storage illumination 32. These LED strips 72 can be connected to the output jacks JJ1 of the power output module(s) 62, which are powered by the driver 52 connected to the input jacks J1 of the power input module 60. Zone 2 can be illuminated using LED strips 72 that are mounted within the interiors of the glass door cabinets 30 to provide the interior lighting 28. These LED strips 72 can be connected to the output jacks JJ2 of the power output module(s) 62, which are powered by the driver 52 connected to the input jacks J2 of the power input module 60. Zone 3 can be illuminated using LED strips 72 that are mounted on top of the overhead cabinets 26 to provide the soffit lighting 36. These LED strips 72 can be connected to the output jacks JJ3 of the power output module(s) 62, which are powered by the driver 52 connected to the input jacks J3 of the power input module 60.

Each zone can thus have separately controllable lighting and/or can have controllable power to the zone via the available output jacks JJ1, JJ2, JJ3. One or more of the power output modules, or the power input module, or both may be designed to provide specific operational features to any one of the zones or to each of the zones. For example, a zone may be provided with a dimming function, a timer function, selectable illumination patterns (flashing or rolling lights), and/or the like. The power modules 60, 62 may be wall mounted, may be manually operable, may be mounted so as not to be seen, and/or may be operable by remote control. In one example, each component connected to the power output module(s) 62 may be a distinct element or component, substantially different from the other components or elements of the modular power system. Further, the special functionality may be provided by a master bridge or module, which may be any one of the power output modules 62 or may be the power input module 60. Still further, the special functionality for a component or components, such as a LED strip 72, may simply be provided as a part of or on the element or component itself and may be operational only directly on the element or component itself. Still further, a master bridge or module may look like the other bridges or modules but may be the only one provided with the special operational or functional characteristics. The master bridge or module may thus be provided with a programmable microprocessor, a user interface for controlling the operations and functions of the master, and the like. Further, such a master bridge or module may also be factory installed on one of the cabinets before shipping to an installation site or may be installed at the installation site.

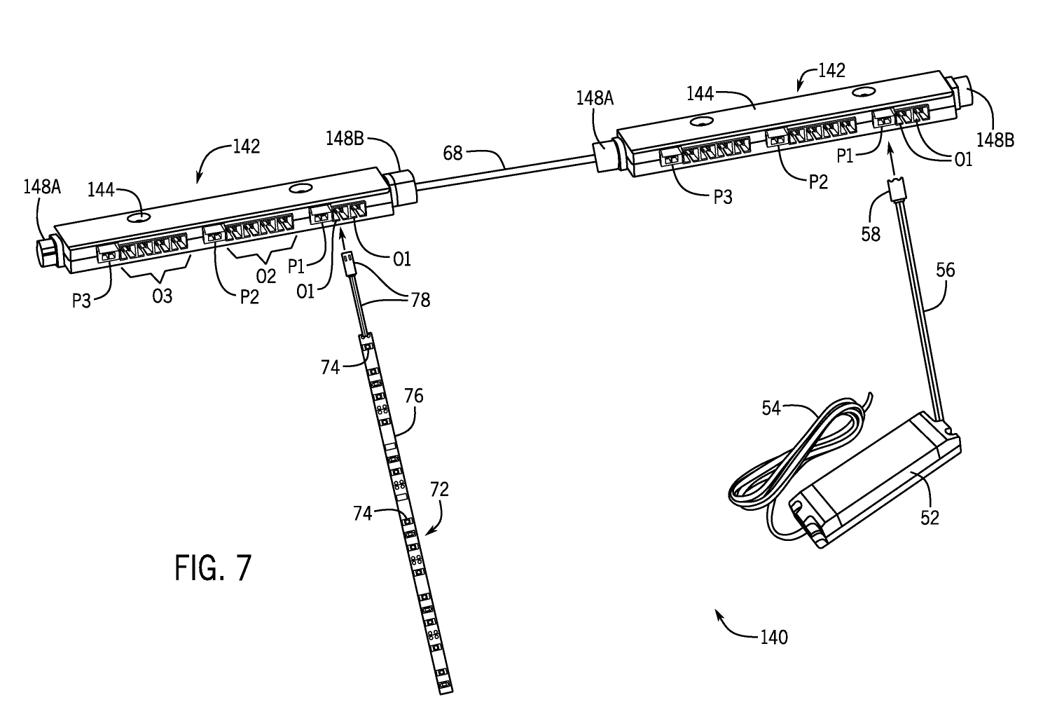

FIG. 7 shows another example of a modular power system 140 in accordance with the teachings of the present disclosure. In this example, the system 140 includes one or more power modules 142. Each power module 142 can have one or more power input jacks exposed on a housing 144. In one example, each power module 142 can include three power input jacks P1, P2, P3 for connecting to three separate drivers 52. The power modules 142 can also have a plurality of output jack groups, including a group electrically connected to each of the power input jacks P1, P2, P3. The power output jacks can thus include three groups of output jacks O1, O2, O3 exposed on the housing 144. Similar to the above-described power output modules 62, multiple components or powered elements, such as LED strips 72, can be connected to the output jacks O1, O2, O3, as needed. The output jacks O1 would be powered by a driver 52 connected to the power input jack P1. The output jacks O2 would be powered by a driver 52 connected to the power input jack P2. The output jacks O3 would be powered by a driver 52 connected to the power input jack P3.

Each power module 142 can also have connectors 148A, 148B configured to connect to a cable 68, as described above. Thus, multiple power modules 142 can be connected to one another in series to provide accessible output jacks O1, O2, O3 throughout a cabinet system 20. In such an example, each driver 52 could be coupled to the modular power system 140 at any one of the power modules 142. In this example, the power module 142 acts as both a power input module and a power output module and thus is a stand-alone power bridge or module. The modular power system 140 can include a plurality of the power bridges or modules 142, just two of which are depicted in FIG. 7.

Referring to FIGS. 1 and 6, in one example, one or more of the power bridges or modules, including the modules 60, 62 or the modules 142, can be installed on the top of the overhead cabinets 26 in a cabinet system 20. Each power bridge or module can be oriented facing rearward and positioned directly adjacent a typical, upward extending facia panel on the top front edge of the respective overhead cabinet 26. The facia panels can thus hide the power bridges or modules so that they are not visible on the installed cabinets. Alternatively, any one or more of the power modules 60, 62 or the modules 142 may be installed on the interior of a cabinet of on an underside of a cabinet, as desired. In another example, the power bridges or modules may also be installed on any one of or each of the base cabinets 38 of the cabinet system 20. In such a case, each power bridge or module may be positioned on the interior of a base cabinet, under a depending baseboard panel on a base cabinet 38, or onto a downward facing surface of an inwardly stepped portion, i.e., a foot space of a base cabinet. The base cabinets 38 may be tied into the upper or overhead cabinet zones, or may be on one or more separate zones, if desired.

The cables 68 can include sufficient wiring to accommodate any number of separately powered zones of a cabinet system 20. The mating connectors 70A and 70B can thus also be configured to accommodate the appropriate number of zones as well. Thus, the mating connectors of the cable can include more or fewer sockets and terminals, depending on the number of zones for a particular modular power system. Likewise, the connectors 64A, 64B and 66A, 66B, or the connectors 148A, 148B, can also be configured to match the connectors of the cables 68 in order accommodate any number of separately powered zones. The power input module 60 and power output module 62 can thus be configured to accommodate fewer or additional zones as well by including fewer or additional groups of input jacks Jn and output jacks JJn. Likewise, the power modules 142 can be configured to accommodate fewer or additional zones as well by including fewer or additional input jacks Pn and output jacks On. Still further, each group of output jacks JJn on an output module 62 or On a power module 142 can include more or fewer jacks, depending on a modular power system design. In the disclosed examples, two of the jack groups include four output jacks and one of the jack groups includes only two output jacks. The number of jacks in each output group can vary from one to n as needed for a given system design.

The power bridges or modules 60, 62, 142 may be provided with integral brackets or separate brackets, as part of the components, for attaching the power bridges or modules to the cabinets. In other examples, the housings 90, 110, 144 may be provided with protruding attachment flanges with fastener holes for securing or fastening the power bridges or modules to the cabinets. The power bridges or modules 60 and 62 or 142 may be mounted to the cabinets at the factory and thus can be delivered to an installation site pre-installed on the cabinets. The cables 68 and/or the drivers 52 may also be installed on the cabinet system at the factory, design permitting, with no or only minimal connections having to be made at the installation site. Alternatively, one end of the cables 68 may be connected to a corresponding one of the power bridges or modules at the factory, while the other ends are hanging free during shipping. The other ends can then be connected to the appropriate adjacent power bridges or modules when the cabinets are installed at the installation site.

The connectors 64A, 64B and 66A, 66B, or 148A, 148B, on the power bridges or modules and the mating connectors 70A, 70B on the cables 68 may be designed to attach in only one orientation, or may be designed to attach in two or more orientations, if desired, while still making the proper power and zone connections between power bridges. With reference to FIGS. 3D, 3E, 4D, and 4E, the various connectors in the disclosed examples are provided with a shaped connection allowing for only a single connection orientation. This prevents the connections from being made incorrectly and also makes assembly and installation fast and easy.

In the disclosed modular power system 50, the type and number of the connection points for various powered components, such as the LED strips 72, may be defined by characteristics of the elements and components of the modular power system. The modular power system 50 may be designed to accommodate a specific cabinet system. Thus, the parts of the system can be customer ordered and designed. The parts can thus have a unique housing size and shape as well as a specific number and arrangement of connectors, jacks, output jack groups, and powered zones. Instead, the modular power system 50 can include generic or standard parts or a range of standard part variations. Parts can be selected from these standard parts to accommodate a range of cabinet systems and powered zones.

During fabrication of the cabinets or a cabinet system, or during installation at the installation site, it may be necessary to drill holes for cable access in some of the cabinets. For example, when connecting two bridges or modules of the modular power system on two adjacent cabinets, it may be necessary to drill a hole extending between the two cabinets so that a cable is not readily visible after installation. In another example, it may be necessary to drill a hole through one of the cabinets so that the lead of a LED strip (or other component or accessory) can reach from the installed location of the LED strip to the power bridge or module on the cabinet, which may or may not be in the same space or location as the LED strip or component. It may also be necessary for an installer to trim the LED strips to a desired length and/or to connect a lead and connector or plug to the LED strip at the installation site. Alternatively, the LED strips or components may be trimmed and installed on or in the cabinets at the factory. Depending on the type of component or accessory, the same might be required or possible for such other components or accessories that are to be provided as a part of the cabinet system and installation.

If desired, fewer than all of the cabinets for a given cabinet system and installation may be provided with a component or accessory at the factory. Those cabinets without a component may not be linked to the modular power system, unless a component or accessory is later installed at the installation site. Thus, those unlinked cabinets may not have lighting or power access points.

As noted above, each driver 52 may be plugged into a separate wall outlet or a separate socket of the same outlet at the installation site. Alternatively, the drivers 52 could instead be hard wired directly to the power source of the installation site, such as a traditional 120V AC system. In either case, the connection to the power source may be a switched connection. Each driver 52 can have an independent connector or plug 58 that can be connected to a power input jack or a power module of the modular power system. Each driver 52 can be connected to the same power input or power module, but to a different but appropriate access point, i.e., port or jack on that module. Alternatively, each driver 52 can be connected to an access port or jack on a different module than any one or more of the other drivers.

Each power module of the modular power system can be connected in series with one or more other modules of the modular power system by connecting two adjacent modules via a cable connected to the appropriate connectors. Various components or accessories can be connected to a desired zone of the modular power system by connecting a selected component or accessory, such as a LED strip 72, to an appropriate access jack for that zone on a module.

In general, one example of a method of installing the disclosed modular power system 50 includes installing one of the power input modules 60 on any cabinet of a cabinet system 20 and installing one of the power output modules on each of the cabinets of the system at the factory or at least one each cabinet or cabinet pair that is to include power access, lighting, or the like. Alternatively, a power module 142 can be installed on each of the cabinets of the system or at least on the cabinets selected for power access, lighting, or the like. The modules can be installed at a neutral location or position on each cabinet. Alternatively, a module can be installed at a specified position or location on each specific cabinet, if needed to accommodate a custom cabinet system and installation design.

If desired, one or more of the components or accessories to be powered by the modular power system may also be installed on the cabinets at the factory. For example, a LED strip 72 can be installed at the factory to each cabinet of the cabinet system 20 that is to be or provide illumination. The components or accessories can be fully installed and connected to the power modules, such as the power output modules 62 or the power modules 142, of the modular power system at the factory. Alternatively, one or more of the components or accessories can at least be partly installed by being secured to the appropriate location on a given cabinet. Further, one or more of the drivers 52 may be attached to or installed on the cabinets at the factory. If drivers or components or accessories are installed at the factory, their connections to the power modules may also be made at the factory, if possible or practical, prior to installation of the cabinets at the installation site. The cabinets can then be shipped or delivered to a site for installation at the site. The cabinets, which carry at least the factory installed parts of the modular power system 50, can be installed at the site to create a cabinet system 50. The driver cords 54 can then be connected to or plugged into the on-site electrical power source during or after the cabinet system is installed at the installation site. If not done at the factory, any one or more of the connectors and leads for the cables, drivers, and/or components or accessories may be connected at the installation site. This can be done for any one or more of the powered zones provided or defined by the modular power system 50.

Once the cabinets are installed and the parts of the modular power system are fully connected, each of the powered zones, such as Zones 1, 2, and 3 of the cabinet system 20, will be linked and powered. If not installed at the factory, a component or accessory can then be selected for installation on or in a cabinet and at a desired location on or in that cabinet. Some components or accessories may be more suitable for being installed and/or connected at the installation site. For example, a phone charger or charging system, a Bluetooth device, a Bluetooth speaker system, a tablet screen or display, or the like may be easily connected to a power module of the modular power system after the cabinet system 20 is installed.

The components and accessories, or portions thereof, may be factory installed as a part of the cabinet system. Alternatively, one or more of the components or devices may be installed and/or connected during cabinet installation. The modular power system may include additional connections between the power bridges or modules and the components or accessories. Adapters may be provided or required to connect between one type of connector on a particular component or accessory and another type of connector provided on the power bridges or modules. In the disclosed examples, each separately powered zone has only one driver 52. Thus, for a system utilizing the separate power input module 60, the modular power system 50 would include only one power input module. For a system utilizing the combined power modules 142, each zone should have only one driver connected for that zone, but the driver for a first zone can be connected to one power module and the driver for a different second zone could be connected to the same power module or a different power module but to the different zone grouping of jacks.

Alternatively, the power bridges or modules may be provided with more than one type of input port or jack and more than one type of output port or jack, depending on a specific system design. In one example, the power input jacks may be configured differently than the power output jacks. The power input jacks may be 5 AMP jacks whereas the power output jacks may be 3 AMP jacks. In another example, some of the output jacks may be configured differently than others. In the disclosed examples, the power output modules 62, or the power modules 142, in a given modular power system 50 are each configured and connected in a way so that a component or accessory can be connected to an output jack of a selected zone using any one of the modules. Likewise, multiple components or accessories can be connected to the same zone on the same module as long as there is an available output jack for that zone group on that module.

Although certain modular power systems, lighting systems, system components and accessories, and installation methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A cabinet system with a modular power system, the cabinet system comprising:
at least one cabinet;
a factory installed power module on the at least one cabinet, the factory installed power module configured to be coupled to a power source for delivering power to the cabinet and to be coupled to a component or accessory that requires power from the power source at an installation site for the at least one cabinet.

2. The cabinet system of claim 1, wherein the factory installed power module includes a power input module installed on the at least one cabinet at the factory.

3. The cabinet system of claim 1, wherein the factory installed power module includes a power output module installed on the at least one cabinet at the factory.

4. The cabinet system of claim 1, wherein the factory installed power module includes a power input module and one or more separate power output modules installed on the at least one cabinet at the factory.

5. The cabinet system of claim 1, wherein the factory installed power module includes a power module with both power input capability and power output capability and wherein the power module is installed on the at least one cabinet at the factory.

6. The cabinet system of claim 1, further comprising a driver for delivering power to the factory installed power module, wherein the driver is connected to the factory installed power module at the factory or at the installation site.

7. The cabinet system of claim 1, further comprising at least two cabinets, each cabinet including a factory installed power module.

8. The cabinet system of claim 7, further comprising a driver coupled to one of the factory installed power modules for delivering power to both of the factory installed power modules.

9. The cabinet system of claim 1, wherein the factory installed power module is a power output module including multiple sets of output jacks, wherein each set of output jacks is configured for a different and separately powered zone of the modular power system.

10. The cabinet system of claim 9, further comprising a power input module including multiple power input jacks, one for each of the different and separately powered zones, wherein the power input module is connectable to the power output module, and wherein each power input jack is configured to optionally connect to a driver to deliver power to the corresponding set of output jacks.

11. A modular power system for cabinets, the modular power system comprising:
a power module configured to be installed on a cabinet, the power module defining multiple different and separately powered zones;
a driver configured to be connected to a power source and to be coupled to the power module; and
a component or accessory configured to be coupled to the power module and to be powered by the driver.

12. The modular power system of claim 11, wherein the power module includes a power input module configured to be installed on a cabinet at the factory.

13. The modular power system of claim 11, wherein the power module includes a power output module configured to be installed on a cabinet at the factory.

14. The modular power system of claim 11, wherein the power module includes a power input module and a separate power output module each configured to be installed on a cabinet at the factory and connected to one another.

15. The modular power system of claim 11, wherein the power module includes both power input capability and power output capability and is configured to be installed on a cabinet at the factory.

16. The modular power system of claim 11, wherein the driver is configured to be installed on a cabinet at the factory and is configured to be connected to a power source at an installation site for the cabinet.

17. The modular power system of claim 16, wherein the driver is configured to be connected to the power module at the factory.

18. The modular power system of claim 11, wherein the power module includes multiple sets of output jacks, each set of output jacks configured for a different and separately powered zone of the modular power system.

19. The modular power system of claim 18, wherein the power module further comprises multiple power input jacks, one for each of the different and separately powered zones, wherein each power input jack is configured to optionally connect to a driver to deliver power to the corresponding set of output jacks.

20. A method of installing a modular power system for cabinets, the method comprising the steps of:
selecting a power module of a modular power system;
installing the power module on a cabinet at a factory; and
delivering the cabinet to an installation site.

21. The method of claim 20, further comprising the steps of coupling a driver to the power module and connecting the driver to a power source at the installation site.

22. The method of claim 20, further comprising the steps of installing a component or accessory on the cabinet at the factory and coupling the component or accessory to the power module at the factory or at the installation site.

23. The method of claim 20, wherein the component or accessory is an LED strip and the step of installing includes securing the LED strip to the cabinet at the factory.
